(19) United States
(12) Patent Application Publication
(10) Pub. No.: US 2026/0158880 A1
(43) Pub. Date: Jun. 11, 2026

(54) WINDOW REGULATOR

(71) Applicant: Johnan Manufacturing Inc., Ueda-shi (JP)

(72) Inventor: Naoki TOKORO, Ueda-shi (JP)

(73) Assignee: Johnan Manufacturing Inc., Ueda-shi (JP)

(21) Appl. No.: 19/378,649

(22) Filed: Nov. 4, 2025

(30) Foreign Application Priority Data
Dec. 10, 2024 (JP) 2024-216038

(51) Int. Cl. B60J 1/17; E05F 15/689; E05F 15/697

(52) U.S. Cl. CPC B60J 1/17; E05F 15/6892; E05F 15/697; E05Y 2900/55

(57) ABSTRACT

A window regulator includes a glass holder and a carrier plate. The carrier plate includes a holder receiving portion that includes a pair of upright wall portions and receives the glass holder between the pair of upright wall portions, a holder engagement portion that is formed on one of the upright wall portions, engages the glass holder received in the holder receiving portion, and is disengaged from the glass holder when the upright wall portions separate, and a placement portion that is formed on the one of the upright wall portions, provides a location to place a round bar-shaped removal tool to be rotated upward to push up the glass holder received in the holder receiving portion, and serves as a fulcrum to rotate the removal tool. The placement portion includes an inclined surface that slopes up in a direction in which the pair of upright wall portions separate.

The present patent application claims the priority of Japanese patent application No. 2024/216038 filed on December 10, 2024, and the entire contents of Japanese patent application No. 2024/216038 are hereby incorporated by reference.

### Technical Field

The present invention relates to a window regulator.

### Background Art

A window regulator is known in which a lower portion of a glass holder is inserted between upright walls of a carrier plate and the glass holder is thereby attached to the carrier plate (see Patent Literature 1). This window regulator includes a carrier plate which has two upright walls and is arranged so as to be movable along the ascending/descending direction, and a glass holder which is fixed to a window glass and is assembled to the carrier plate. Since the window regulator is configured such that the glass holder is attached to the carrier plate by inserting the lower portion of the glass holder between the two upright walls of the carrier plate, the glass holder can be easily attached to the carrier plate.

### Citation List

### Patent Literature

Patent Literature 1: JP 2024/049412A

### Summary of Invention

In the known window regulator, a problem may arise that removal of the glass holder from the carrier plate requires pushing apart the upright walls and then pulling the glass holder upward while keeping it in that state and the removal work of removing the glass holder from the carrier plate is thus complicated.

It is an object of the invention to provide a window regulator that can improve the workability of removal work of removing a glass holder from a carrier plate.

An aspect of the invention provides a window regulator, comprising:

a glass holder to hold a window glass;

a carrier plate to which the glass holder is fixed; and

a raising/lowering unit to raise and lower the carrier plate,

wherein the carrier plate comprises a holder receiving portion that comprises a pair of upright wall portions and receives the glass holder between the pair of upright wall portions, a holder engagement portion that is formed on one of the upright wall portions, engages the glass holder received in the holder receiving portion, and is disengaged from the glass holder when the pair of upright wall portions separate, and a placement portion that is formed on the one of the upright wall portions, provides a location to place a round bar-shaped removal tool to be rotated upward to push up the glass holder received in the holder receiving portion, and serves as a fulcrum to rotate the removal tool, and

wherein the placement portion comprises an inclined surface that slopes up in a direction in which the pair of upright wall portions separate.

### Advantageous Effects of Invention

A window regulator according to an embodiment of the invention can improve the workability of removal work of removing the glass holder from the carrier plate.

### Brief Description of Drawings

FIG. 1 is a general schematic diagram illustrating a window regulator in an embodiment of the present invention and a vehicle door on which the window regulator is provided.

FIG. 2 is a front view showing the window regulator.

FIG. 3A is a front view showing a glass holder unit and a carrier plate.

FIG. 3B is a side view showing the glass holder unit and the carrier plate.

FIG. 3C is a rear view showing the glass holder unit and the carrier plate.

FIG. 4A is a front view showing the carrier plate.

FIG. 4B is a side view showing the carrier plate.

FIG. 4C is a rear view showing the carrier plate.

FIGS. 5A and 5B are schematic cross-sectional views taken along line A-A’ in FIG. 3A, showing the glass holder and a holder fixing portion.

FIG. 6A is a front view showing the glass holder unit.

FIG. 6B is a side view showing the glass holder unit.

FIG. 6C is a rear view showing the glass holder unit.

FIG. 7A is a schematic plan view showing the glass holder unit.

FIG. 7B is a schematic plan view showing the glass holder unit when holding a window glass.

FIGS. 8A and 8B are first explanatory diagrams illustrating a glass holder removal operation.

FIGS. 9A and 9B are second explanatory diagrams illustrating the glass holder removal operation.

### Description of Embodiments

A window regulator in an embodiment of the invention will be described below with reference to the appended drawings. This window regulator is a raising/lowering device that is installed in a vehicle door provided on a vehicle (e.g., an automobile) and raises/lowers a window glass on the vehicle door. In particular, this window regulator has a holder fixing structure that allows the glass holder to be attached to the carrier plate using a snap-fit mechanism, where the shape of a holder fixing portion of the carrier plate is devised to improve the workability of removal work of removing the glass holder from the carrier plate. Hereinafter, an ascending/descending direction of the window glass of the vehicle will be simply referred to as the ascending/descending direction. In addition, left, right, front, rear, up and down used in the following description are as defined in each drawing. In the present embodiment, the ascending/descending direction coincides with the up-down direction of the window regulator, and a vehicle width direction coincides with a front-rear direction of the window regulator. In addition, a direction orthogonal to the ascending/descending direction and the vehicle width direction is a left-right direction of the window regulator.

### Configuration of the window regulator

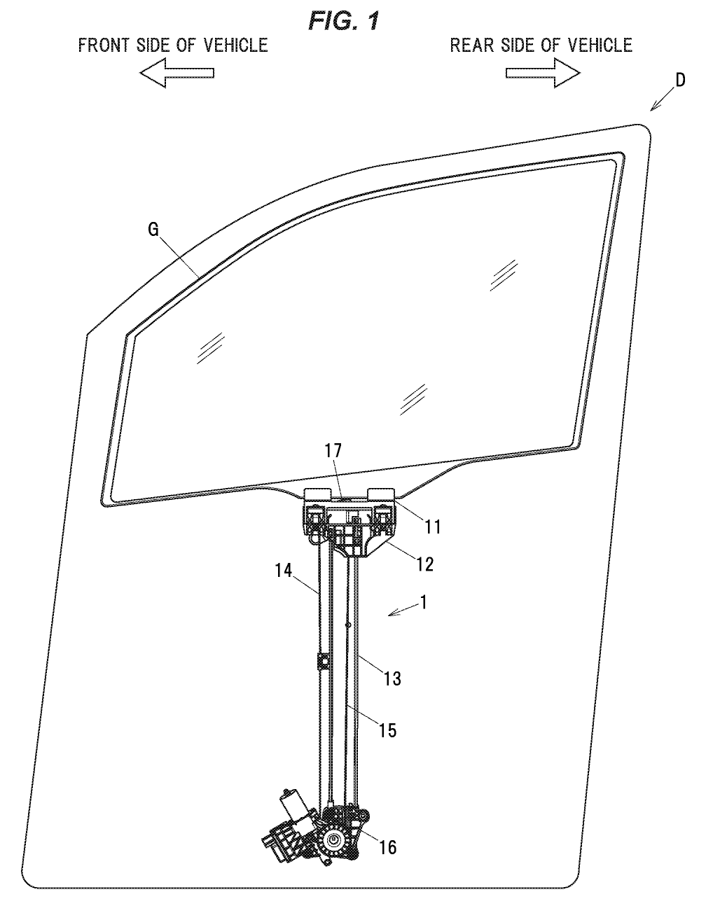

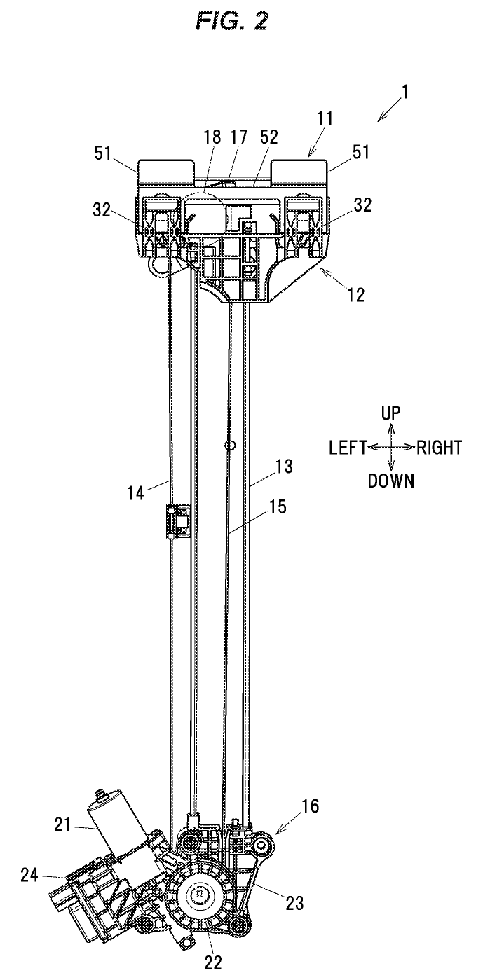

As shown in FIGS. 1 and 2, a window regulator 1 is installed on a vehicle door D and includes a glass holder unit 11 to hold a window glass G, a carrier plate 12 to which the glass holder unit 11 is fixed, a guide rail 13 that supports the carrier plate 12 so as to be slidable in the ascending/descending direction, an ascending-side wire 14 and a descending-side wire 15 that pull the carrier plate 12, a drive unit 16 that is arranged at a lower end of the guide rail 13 to drive the ascending-side wire 14 and the descending-side wire 15, and a pulley 18 that is provided at an upper end of the guide rail 13 through a pulley bracket 17 and changes the direction of the ascending-side wire 14. That is, this window regulator 1 is a wire driving-type window regulator to raise and lower the carrier plate 12 using the wires 14, 15 and is also a lower end drive-type window regulator having the drive unit 16 arranged at the lower end of the guide rail 13. The guide rail 13, the ascending-side wire14, the descending-side wire 15 and the drive unit 16 are an example of the raising/lowering unit to raise and lower the carrier plate 12.

The guide rail 13 is formed by bending a long metal plate so as to be curved toward the outside of a vehicle cabin (toward the front side) at a predetermined curvature, and extends in the ascending/descending direction. The guide rail 13 supports the carrier plate 12 so as to be slidable in the ascending/descending direction.

The ascending-side wire 14 is connected at one end to a rotating drum 22 (described later) of the drive unit 16, is fed upward from the drive unit 16 to the pulley 18, is redirected downward by the pulley 18, and is then attached at the other end to the carrier plate 12. The descending-side wire 15 is connected at one end to the rotating drum 22 of the drive unit 16, is fed upward from the drive unit 16, and is attached at the other end to the carrier plate 12.

As shown in FIG. 2, the drive unit 16 has a motor 21, the rotating drum 22 that is rotationally driven by the motor 21 and takes up and feeds out the ascending-side wire 14 and the descending-side wire 15 by rotating, a reducer (not shown) to transfer rotation of the motor 21 to the rotating drum 22, a drum housing 23 to which the lower end of the guide rail 13 is fitted and in which the rotating drum 22 is rotatably housed, and a motor housing 24 holding the motor 21. The motor housing 24 incorporates the reducer and is fixed to the drum housing 23 so as to cover a drum housing portion of the drum housing 23.

When the motor 21 is rotated in forward, the rotating drum 22 rotates in the forward direction and accordingly takes up the ascending-side wire 14 while feeding out the descending-side wire 15. Thus, the carrier plate 12 is pulled by the ascending-side wire 14 and moves upward in the ascending/descending direction. As a result, the glass holder unit 11 attached to the carrier plate 12 and the window glass G are raised. On the other hand, when the motor 21 is rotated in reverse, the rotating drum 22 rotates in the reverse direction and accordingly takes up the descending-side wire 15 while feeding out the ascending-side wire 14. Thus, the carrier plate 12 is pulled by the descending-side wire 15 and moves downward in the ascending/descending direction. As a result, the glass holder unit 11 attached to the carrier plate 12 and the window glass G are lowered. In this manner, the carrier plate 12, the glass holder unit 11 and the window glass G are raised and lowered along the guide rail 13 (operations of raising and lowering the window glass G).

### Configuration of the carrier plate

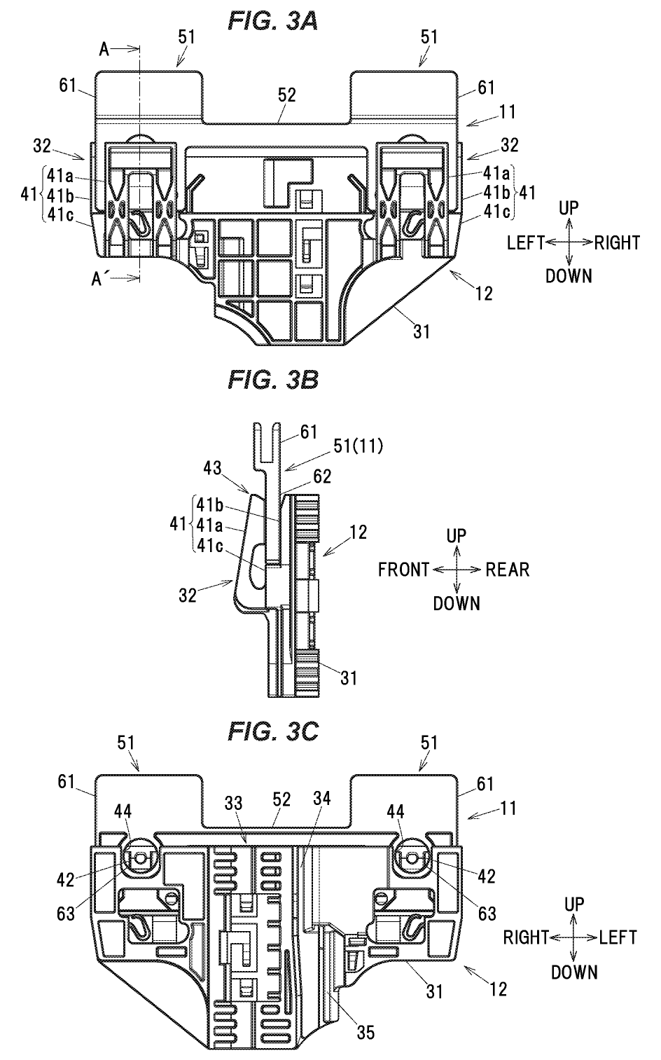

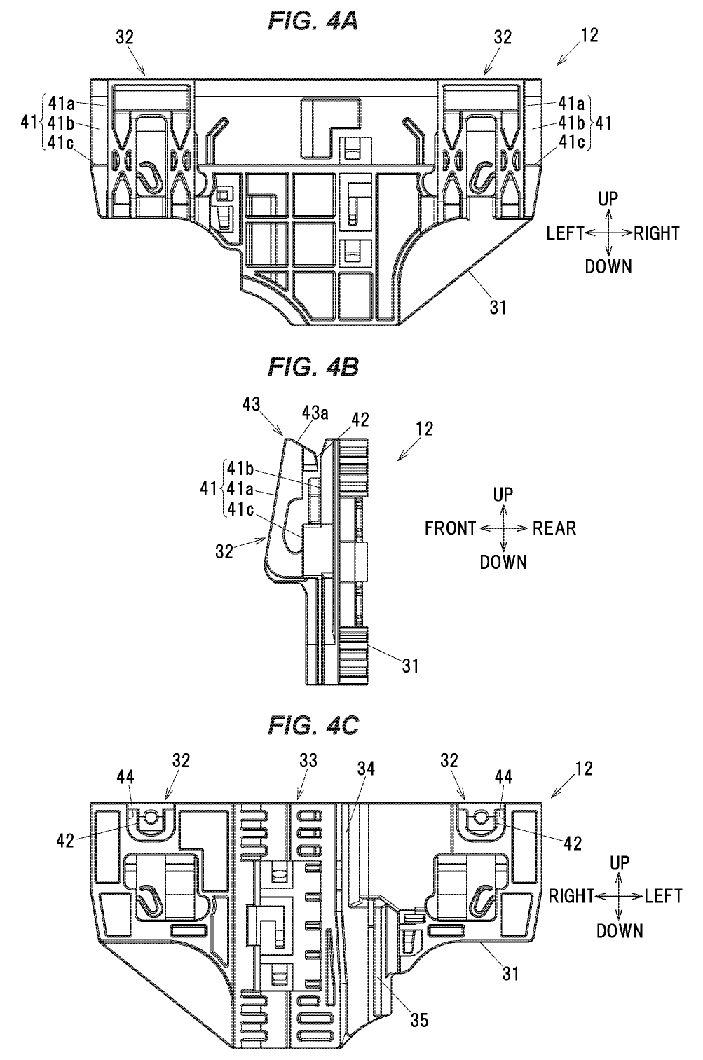

As shown in FIGS. 3A to 4C, the carrier plate 12 is formed of a resin (e.g., polyacetal), and has a plate-shaped main body 31, two holder fixing portions 32, 32 formed at right and left ends of the main body 31, a rail sliding portion 33 formed on the rear surface of the main body 31 on the slightly right side of the center, a descending-side wire attachment portion 35 formed on the main body 31 on the left of the rail sliding portion 33, and an ascending-side wire attachment portion 34 formed on the main body 31 on the right of the descending-side wire attachment portion 35. In the present embodiment, the glass holder unit 11 is attached to the carrier plate 12 by respectively fixing two glass holders 51, 51 of the glass holder unit 11 to the two holder fixing portions 32, 32.

The rail sliding portion 33 slides against a right-side plate portion of the guide rail 13. That is, the rail sliding portion 33 sliding against the right-side plate portion allows the carrier plate 12 to be slidably supported on the guide rail 13.

One end of the ascending-side wire 14 is attached to the ascending-side wire attachment portion 34. One end of the descending-side wire 15 is attached to the descending-side wire attachment portion 35. That is, the carrier plate 12 is configured to be pulled upward in the ascending/descending direction by the ascending-side wire 14 through the ascending-side wire attachment portion 34 and to be pulled downward in the ascending/descending direction by the descending-side wire 15 through the descending-side wire attachment portion 35.

Each of the holder fixing portions 32, 32 has a holder receiving portion 41 that is composed of a pair of front and rear upright wall portions 41a, 41b and a bottom wall portion 41c and receives a fixed portion 62 (described later) of the glass holder 51 between the pair of upright wall portions 41a, 41b, a holder engagement portion 42 that is formed inside the holder receiving portion 41 and engages the fixed portion 62 of the glass holder 51 received in the holder receiving portion 41, a placement portion 43 which is formed on the front upright wall portion 41a and on which a tip side of a round bar-shaped removal tool T is placed, and a cutout groove 44 formed on the rear upright wall portion 41b. In the present embodiment, each of the glass holders 51, 51 is pushed up by rotating the round bar-shaped removal tool T upward, thereby removing each of the glass holders 51, 51 from the carrier plate 12. In this regard, it is assumed that, e.g., a tool such as a screwdriver is used as the round bar-shaped removal tool T.

The holder receiving portion 41 has the pair of upright wall portions 41a, 41b that sandwich the fixed portion 62 of the glass holder 51 from the front and rear, and the bottom wall portion 41c on which the fixed portion 62 of the glass holder 51 is placed. The front upright wall portion 41a is configured to be able to pivot and deform so as to tilt toward the front side.

The holder engagement portion 42 is formed to protrude rearward from the front upright wall portion 41a, engages an engagement hole 63 (described later) formed on the fixed portion 62 of the glass holder 51, and thereby locks the fixed portion 62 of the glass holder 51. A lower end surface of the holder engaging portion 42 has an arc shape that conforms to a lower inner surface of the engagement hole 63.

Then, an upper end surface of the holder engagement portion 42 is an inclined surface that slopes down toward the rear side. Due to the configuration in which the upper end surface of the holder engagement portion 42 is an inclined surface sloping down toward the rear side and the front upright wall portion 41a is configured to be able to pivot and deform so as to tilt toward the front side, the fixed portion 62 of the glass holder 51 can be snap-fitted to the holder fixing portion 32. In detail, when inserting the fixed portion 62 of the glass holder 51 into the holder receiving portion 41 from above, the fixed portion 62 of the glass holder 51 comes into contact with the upper end surface of the holder engagement portion 42, and the holder engagement portion 42 is pushed at the inclined surface toward the front side, causing the front upright wall portion 41a to pivot toward the front side and the holder engagement portion 42 to retreat toward the front side. This allows the fixed portion 62 of the glass holder 51 to enter the holder receiving portion 41. After that, when the fixed portion 62 of the glass holder 51 advances further into the holder receiving portion 41 and the engagement hole 63 on the fixed portion 62 reaches the position of the holder engagement portion 42, the holder engagement portion 42 enters and engages the engagement hole 63, and the fixed portion 62 of the glass holder 51 is thereby fixed to the holder fixing portion 32. In this way, the fixed portion 62 of the glass holder 51 is fixed (fastened) to the holder fixing portion 32 simply by inserting the fixed portion 62 of the glass holder 51 into the holder receiving portion 41 from above.

In addition, the holder engagement portion 42 is configured to be disengaged from the engagement hole 63 when the upright wall portion 41a pivots toward the front side (when the pair of upright wall portions 41a, 41b separate). Therefore, when removing the glass holder 51 from the holder fixing portion 32, the upright wall portion 41a is pivoted toward the front side to disengage the holder engagement portion 42 from the engagement hole 63 and the glass holder 51 is then pushed up in that state, thereby removing the glass holder 51 from the holder fixing portion 32.

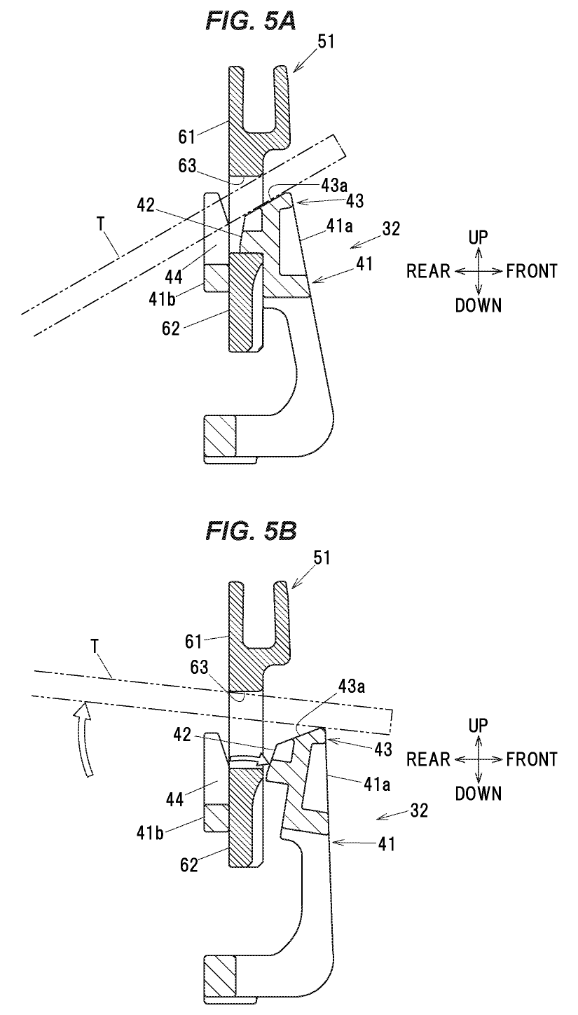

The placement portion 43 is formed at the upper end of the front upright wall portion 41a, provides a location to place the tip side of the round bar-shaped removal tool T and serves as a fulcrum to rotate the removal tool T when pushing up the glass holder 51. In the present embodiment, as shown in FIGS. 5A and 5B, the removal tool T is rotated using the placement portion 43 as a fulcrum in the state in which a middle portion of the round bar-shaped removal tool T is in contact with the glass holder 51, thereby pushing up the glass holder 51 in a similar manner to the second-class lever.

In addition, as shown in FIG. 4B, the placement portion 43 has an inclined surface 43a that slopes up toward the front side (in a direction in which the pair of upright wall portions 41a, 41b separate). Therefore, when pushing up the glass holder 51 by rotating the round bar-shaped removal tool T using the placement portion 43 as a fulcrum, a component force that presses the front upright wall portion 41a toward the front side is generated by the inclined surface 43a, causing the front upright wall portion 41a to pivot toward the front side. Thus, by simply rotating the round rod-shaped removal tool T using the placement portion 43 as a fulcrum, it is possible to cause the upright wall portion 41a to pivot toward the front side, disengage the holder engagement portion 42 from the engagement hole 63, and push up the glass holder 51 in such a state. The time and effort required to remove the glass holder 51 from the holder fixing portion 32 can thereby be reduced.

The cutout groove 44 is a cutout portion that is formed on the rear upright wall portion 41b to avoid contact between the rear upright wall portion 41b and the removal tool T which rotates with the placement portion 43 as a fulcrum. As shown in FIGS. 5A and 5B, due to the positional relationship between the position of the placement portion 43 and the contact position of the fixed portion 62 with the removal tool T, the removal tool T rotates upward from a downwardly inclined position. Therefore, it is preferable that the cutout groove 44 extend from the upper end of the rear upright wall portion 41b to a position lower than the contact position of the fixed portion 62 with the removal tool T (lower than the upper inner surface of the engagement hole 63).

### Configuration of the glass holder unit

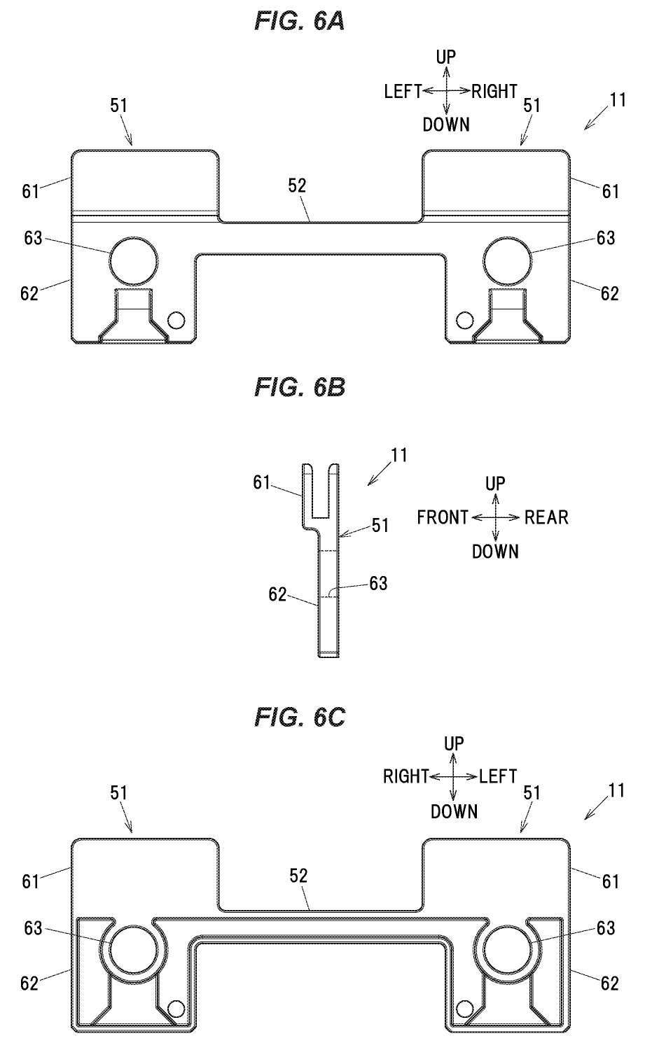

As shown in FIGS. 3A to 3C and 6A to 6C, the glass holder unit 11 is formed of a resin (e.g., polybutylene terephthalate) and has two glass holders 51 on the left and right that hold the lower end portion of the window glass G, and a connecting portion 52 that connects the two glass holders 51. The two glass holders 51 and the connecting portion 52 are molded as one piece by injection molding.

Each glass holder 51 integrally has a glass holding portion 61 that holds the lower end portion of the window glass G, and the fixed portion 62 that extends downward from a lower end of the glass holding portion 61 and is fixed to the carrier plate 12.

The glass holding portion 61 has a rectangular shape as viewed from the front and a squared “U” shape as viewed from a side, and holds the lower end portion of the window glass G in a sandwiching manner. The lower end portion of the window glass G is held by the glass holding portions 61 and, in this state, is fixed to the glass holding portions 61 with an adhesive, etc. It is preferable that a guide slope to guide the window glass G into the glass holding portion 61 be formed on an inner edge of the upper end of the glass holding portion 61.

The fixed portion 62 is formed in a rectangular plate shape as viewed from the front, and has the engagement hole 63 which is a circular opening formed to penetrate therethrough. The lower half of the engagement hole 63 serves as an engaged portion at which the holder engagement portion 42 engages the lower inner surface of the engagement hole 63, while the upper half serves as a contacted portion at which the removal tool T comes into contact with the upper inner surface of the engagement hole 63. Therefore, in the state in which the glass holder 51 is attached to the holder fixing portion 32, the lower end surface of the holder engagement portion 42 engages the lower inner surface of the engagement hole 63. Then, when removing the glass holder 51 from the holder fixing portion 32, an upper surface of the removal tool T comes into contact with the upper inner surface of the engagement hole 63 and pushes up the glass holder 51. The positions of the placement portion 43 and the engagement hole 63 are designed to have a positional relationship in which the removal tool T with its tip side placed on the placement portion 43 can pass through the engagement hole 63. Furthermore, a separation distance (amount of positional difference) between the placement portion 43 and the upper inner surface of the engagement hole 63 in the up-down direction is preferably not less than the diameter of the removal tool T.

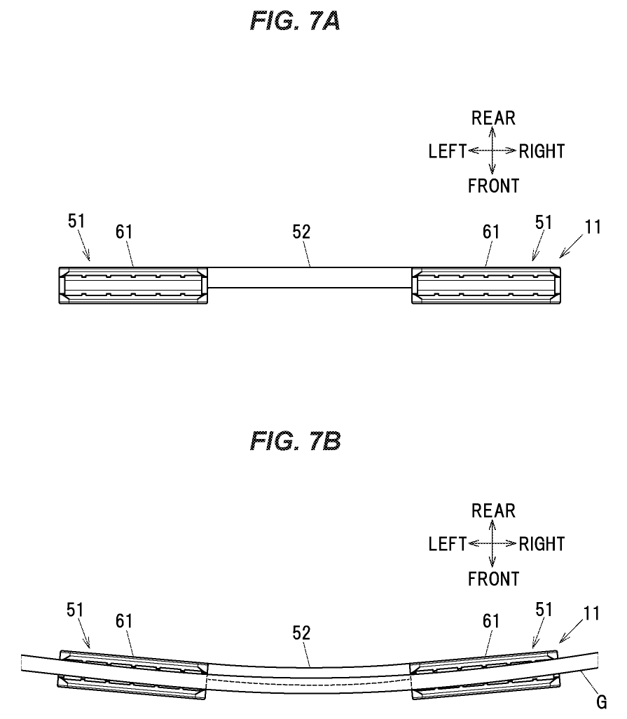

The connecting portion 52 is formed in a rectangular bar shape horizontally extending from the left end of the right glass holder 51 to the right end of the left glass holder 51, and connects the left and right glass holders 51. The connecting portion 52 is a low-rigidity portion as a whole, and is configured to be able to bend and deform in the front-rear direction. Thus, the connecting portion 52 is configured to be able to deform to conform to the curvature of the window glass G about the up-down direction (the curvature of the lower end portion of the window glass G), as shown in FIG. 7B. Therefore, when attaching each glass holder 51 to the lower end portion of the window glass G, the connecting portion 52 is deformed to conform to the curvature of the window glass G as shown in the same figure, which allows the orientation of the glass holding portion 61 of each glass holder 51 to conform to the curvature of the window glass G and thus the glass holding portion 61 of each glass holder 51 to follow the curvature of the window glass G. In the present embodiment, to provide the connecting portion 52 with rigidity that can deform to conform to the curvature of the window glass G about the up-down direction, the rigidity (deformable properties) of the connecting portion 52 is adjusted by reducing the dimension of the connecting portion 52 in the up-down direction and providing a recessed groove extending in the left-right direction on the rear surface of the connecting portion 52.

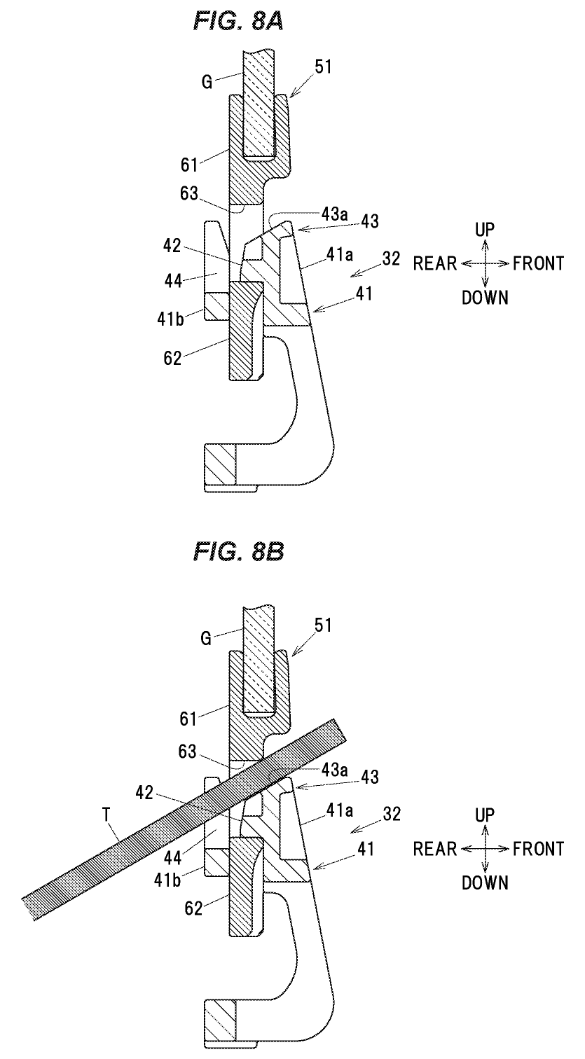

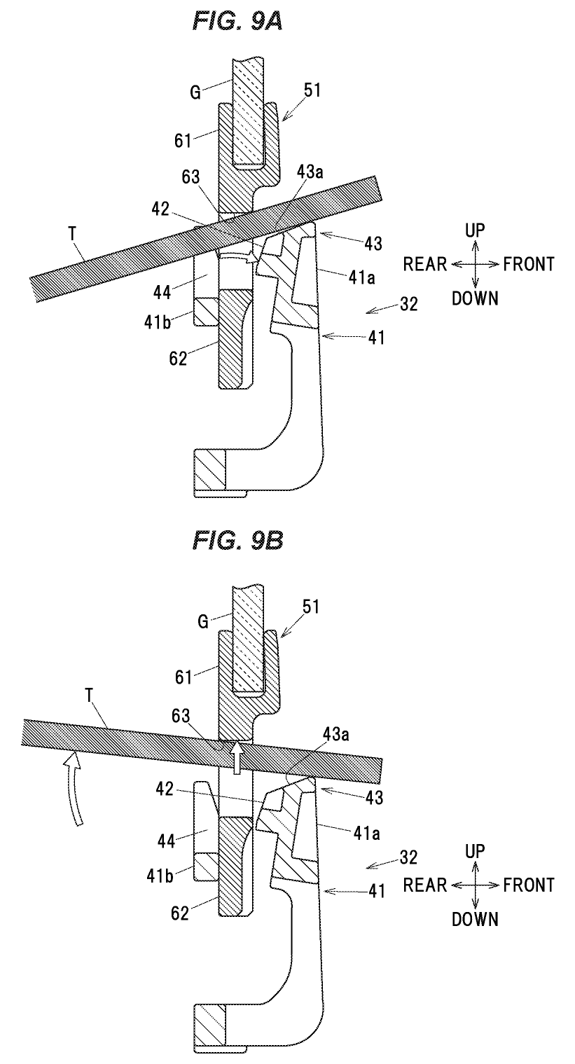

Next, a glass holder removal operation of removing the glass holder 51 from the carrier plate 12 will be described with reference to FIGS. 8A to 9B. This glass holder removal operation starts from a state in which the holder engagement portion 42 engages the engagement hole 63 as shown in FIG. 8A, and is performed by pushing up the glass holder 51 with the removal tool T. Although not shown in the drawings, to perform the glass holder removal operation, the tip side of the removal tool T is inserted into the interior of the vehicle door D through a service hole opened on the door panel (the inner panel).

In the glass holder removal operation, first, the tip side of the removal tool T is placed on the placement portion 43 while inserting the removal tool T through the engagement hole 63, as shown in FIG. 8B. That is, after the tip side of the removal tool T passes through the cutout groove 44 and penetrates the engagement hole 63, the tip side of the removal tool T which has penetrated the engagement hole 63 is placed on the inclined surface 43a of the placement portion 43.

Once the tip side of the removal tool T is placed on the placement portion 43, the removal tool T is rotated upward using the placement portion 43 as a fulcrum, thereby pushing up the glass holder 51, as shown in FIGS. 9A and 9B. At this time, the force pushing up the glass holder 51 applies a load to the placement portion 43 serving as the fulcrum. Therefore, first, the front upright wall portion 41a is pushed toward the front side by a component force generated by the inclined surface 43a and pivots toward the front side, as shown in FIG. 9A. This disengages the holder engagement portion 42 from the engagement hole 63. After that, as shown in FIG. 9B, the contact position with the removal tool T shifts to the upper end surface of the placement portion 43, the front upright wall portion 41a stops pivoting toward the front side, and the removal tool T is rotated upward in the form of pushing up the upper inner surface of the engagement hole 63 while the holder engagement portion 42 remains disengaged from the engagement hole 63. The glass holder 51 is thereby pushed up to a position where the position of the lower inner surface of the engagement hole 63 is shifted to a position above the holder engagement portion 42, and the glass holder removal operation then ends. After simultaneously performing this glass holder removal operation on the glass holders 51 and the holder engagement portions 42 both on the left and right, the window glass G is held by hand and pulled upward in this state, whereby each glass holder 51 is completely removed from each holder fixing part 32 and the glass holder unit 11 is completely detached from the carrier plate 12.

### Functions and Effects of the embodiment

As described above, according to the configuration of the above embodiment, since the placement portion 43 serving as a fulcrum to rotate the removal tool T is provided and the placement portion 43 has the inclined surface 43a, simply rotating the removal tool T upward using the mounting portion 43 as a fulcrum and pushing up the glass holder 51 simultaneously causes the holder engagement portion 42 to be disengaged and the glass holder 51 to be pushed up. As a result, the glass holder 51 can be easily removed from the snap-fit type holder fixing portion 32, and the workability of the removal work of removing the glass holder 51 from the carrier plate 12 can thereby be improved.

In addition, adopting the snap-fit type holder fixing portion 32 allows the glass holder 51 to be easily attached to the carrier plate 12.

In addition, forming the engagement hole 63, which serves as the contacted portion with which the removal tool T comes into contact, on the fixed portion 62 of the glass holder 51 allows the glass holder 51 to be pushed up by the removal tool T at substantially the center of the fixed portion 62. This can suppress tilt of the glass holder 51 to the left or right at the time of pushing up the glass holder 51. This makes it easier to remove the glass holder 51.

In addition, by using the upper half of the engagement hole 63 as the contacted portion with which the removal tool T comes into contact and the lower half of the engagement hole 63 as the engaged portion to be engaged with the holder engagement portion 42, it is not necessary to form two separate engagement holes 63 for the contacted portion and for the engaged portion, hence, the glass holder 51 can have a simple configuration.

In addition, by providing the cutout groove 44 on the rear upright wall portion 41b, contact of the removal tool T with the rear upright wall portion 41b can be avoided at the time of removing the glass holder 51.

### Other embodiments

Although the embodiment of the invention has been described, the invention according to claims is not to be limited to the embodiment described above. Further, please note that not all combinations of the features described in the embodiment are necessary to solve the problem of the invention. The invention can be appropriately modified and implemented without departing the gist thereof.

For example, the shape of the engagement hole 63 is a circular shape in the above embodiment, but the configuration is not limited thereto. For example, the engagement hole 63 may have a Daruma doll shape or an elongated hole shape (a racetrack hole shape). Furthermore, the engagement hole 63 may have, e.g., a rectangular shape or an inverted triangular shape.

In addition, the configuration in the above embodiment is such that the upper half of the engagement hole 63 is used as a contacted portion with which the removal tool T comes into contact, and the lower half of the engagement hole 63 is used as an engaged portion to be engaged with the holder engaging portion 42, but the configuration may be such that two engagement holes 63 are formed, one for the contacted portion and one for the engaged portion.

In addition, the configuration in the above embodiment is such that the engagement hole 63 (an opening) is formed on the fixed portion 62 and the upper inner surface of the engagement hole 63 serves as a contacted portion for the removal tool T, but the configuration is not limited thereto. For example, the configuration may be such that protrusions protruding to the left and right from the fixed portion 62 are provided so as to serve as the contacted portion for the removal toll T, or such that a groove extending upward from the lower end of the fixed portion 62 is formed and the upper inner surface of the groove serves as the contacted portion. Furthermore, the configuration may be such that the lower end of the glass holding portion 61 serves as the contacted portion.

In addition, the configuration in the above embodiment uses two glass holders 51 connected and integrated by the connecting portion 52, but glass holders 51 which are not connected may be used. That is, the invention may be applied to the window regulator 1 including the two glass holders 51 connected and integrated by the connecting portion 52, or the invention may be applied to the window regulator 1 including the glass holders 51 which are not connected.

In addition, in the embodiment described above, the invention is applied to the lower end drive-type window regulator 1 having the drive unit 16 arranged at the lower end of the guide rail 13, but it is not limited thereto. For example, the invention may be applied to a banjo-type window regulator having the drive unit 16 arranged on the guide rail 13 at the center in the up-down direction, or the invention may be applied to a window regulator with the drive unit 16 fixed directly to (a door panel of) the vehicle door D (such as delta-type window regulator, railless window regulator).

In addition, in the embodiment described above, the invention is applied to the wire driving-type window regulator. However, it is not limited thereto, and the invention may be applied to, e.g., an arm-type window regulator.

### REFERENCE SIGNS LIST

1 WINDOW REGULATOR

12 CARRIER PLATE

13 GUIDE RAIL

14 ASCENDING-SIDE WIRE

15 DESCENDING-SIDE WIRE

16 DRIVE UNIT

41 HOLDER RECEIVING PORTION

41a, 41b UPRIGHT WALL PORTION

42 HOLDER ENGAGEMENT PORTION

43 PLACEMENT PORTION

43a INCLINED SURFACE

44 CUTOUT GROOVE

51 GLASS HOLDER

63 ENGAGEMENT HOLE

G WINDOW GLASS

1. A window regulator, comprising:
a glass holder to hold a window glass;
a carrier plate to which the glass holder is fixed; and
a raising/lowering unit to raise and lower the carrier plate,
wherein the carrier plate comprises a holder receiving portion that comprises a pair of upright wall portions and receives the glass holder between the pair of upright wall portions, a holder engagement portion that is formed on one of the upright wall portions, engages the glass holder received in the holder receiving portion, and is disengaged from the glass holder when the pair of upright wall portions separate, and a placement portion that is formed on the one of the upright wall portions, provides a location to place a round bar-shaped removal tool to be rotated upward to push up the glass holder received in the holder receiving portion, and serves as a fulcrum to rotate the removal tool, and
wherein the placement portion comprises an inclined surface that slopes up in a direction in which the pair of upright wall portions separate.

2. The window regulator according to claim 1, wherein the glass holder comprises an opening formed thereon, and wherein the opening comprises an upper inner surface with which the removal tool comes into contact.

3. The window regulator according to claim 2, wherein the opening comprises a lower inner surface with which the holder engagement portion engages.

4. The window regulator according to claim 1, wherein the carrier plate further comprises a cutout portion formed on the other of the upright wall portions to avoid contact between the other upright wall portion and the removal tool that is rotated using the placement portion as a fulcrum.

5. The window regulator according to claim 2, wherein the carrier plate further comprises a cutout portion formed on the other of the upright wall portions to avoid contact between the other upright wall portion and the removal tool that is rotated using the placement portion as a fulcrum.

6. The window regulator according to claim 3, wherein the carrier plate further comprises a cutout portion formed on the other of the upright wall portions to avoid contact between the other upright wall portion and the removal tool that is rotated using the placement portion as a fulcrum.
